(19) United States
(12) Patent Application Publication
(10) Pub. No.: US 2010/0147229 A1
(43) Pub. Date: Jun. 17, 2010

(54) APPARATUS, SYSTEM, AND METHOD FOR TREAT-FILLED DOLLS FOR PETS

(76) Inventor: Juhani C. DeFazio, Sunny Isles, FL (US)

Correspondence Address: Kunzler Needham Massey & Thorpe, 8 EAST BROADWAY, SUITE 600, SALT LAKE CITY, UT, 84111, US

(21) Appl. No.: 12/635,582

(22) Filed: Dec. 10, 2009

Related U.S. Application Data
(60) Provisional application No. 61/121,487, filed on Dec. 10, 2008.
(60) Provisional application No. 61/162,267, filed on Mar. 21, 2009.

(51) Int. Cl. A01K 15/02; A01K 29/00

(52) U.S. Cl. 119/710

(57) ABSTRACT

A treat-filled and disposable pet toy is formed in an attractive and identifiable shape. The toy includes a hook and loop material strip attached to a slit in the doll, which is attached by an attachment material, such as stitching. When the slit is opened, it reveals a cavity that is filled with pet treats. Pets are attracted to the toy because of its smell and appearance. Pets may chew the doll apart, or if the temperament of the dog is milder, the doll may be refilled with treats until worn out.

### CROSS-REFERENCES TO RELATED APPLICATIONS

This application claims priority to U.S. Provisional Patent Application No. 61/121,487 entitled APPARATUS, SYSTEM, AND METHOD FOR TREAT-FILLED DOLLS FOR PETS, and filed on Dec. 10, 2008 for Juhani C. DeFazio and U.S. Provisional Patent Application No. 61/162,267 entitled APPARATUS, SYSTEM, AND METHOD FOR TREAT-FILLED DOLLS FOR PETS, and filed on Mar. 21, 2009 for Juhani C. DeFazio, which is incorporated herein by reference.

### BACKGROUND

1. Field

This invention relates to pet toys, and more especially to treat-filled dolls for pets.

2. Description of Related Art

Dogs, cats, and other domestic pets often play with toys such as balls, ropes, stuffed animals, and other non-edible objects. Such behavior is natural to animals, and can help keep a pet psychologically healthy, as well as physically healthy. Pets need exercise and play for a healthy lifestyle. When there are no toys available for the pets, they may become aggressive with items such as furniture, walls, shoes, or clothing. Having a toy for a pet to chew on may keep an owner's home in better condition, reducing the wear and tear that pets have been known to cause.

Some pet toys, such as rawhide chews, bones, pull ropes, plastic and rubber toys have been introduced to the market and used by pet owners. There have been some chew toys introduced with enhanced features, intended to attract the dog or pet, and to keep it occupied with something other than the owner's items. These toys may have a treat hidden inside, or be flavored with an attractive smell. There are toys made of all kinds of materials, both soft and hard. There are toys in different shapes, whether it be in the shape of a bone, a ball, or another animal. Although these are useful improvements to previous pet toys, many dogs are still unsatisfied with the toys chosen by their owners.

Many of the toys introduced to the market with treats hidden inside are disliked by dogs, sometimes because they are hard or unattractive. Dogs are often attracted to rolled up socks or children's stuffed animals because of the plush appearance and the soft texture of the toy. The plastic and vinyl toys hold less appeal for many dogs, and thus may not solve the problem of chewing the owners' own items.

Additionally, many of the toys introduced to the market with treats inside are intended to be permanent toys for the pets, and priced as such. These toys often become tattered and broken, no longer capable of housing a treat, as was intended upon purchase of the toy. Many of the toys lose their ability to hide a treat, and are no longer useful for their original purpose. These refillable toys are more expensive than disposable ones, while the dog who doesn't know the difference, treats them as if they were disposable. The toys intended to be permanent toys are not actually permanent, and tend to be thrown away after being purchased for a higher price than a disposable toy.

Also, many of the toys introduced to the market are visually unattractive. They have no shape or design that would differentiate them from any other toy, especially children's toys, found around the house. Sometimes the pet will not notice anything different between the chew toy and the owner's favorite shoes or a child's favorite stuffed animal.

### SUMMARY

From the foregoing discussion, it should be apparent that a need exists for an apparatus, system, and method that provide a treat-filled and disposable pet toy in an attractive and recognizable shape. Beneficially, such an apparatus would be filled with a treat for attraction, be soft to the touch, be visually distinguishable from regular balls and chew toys, and be intended for disposal after one or two uses, depending on the temperament and mannerisms of the pet.

The present invention has been developed in response to the present state of the art, and in particular, in response to the problems and needs in the art that have not yet been fully solved by currently available instruction methods. Accordingly, the present invention has been developed to provide an apparatus for the satisfaction of a pet's needs for chew toys that are distinguishable and attractive, while disposable and inexpensive.

The apparatus, in one embodiment, is configured to be a soft doll with an enclosure means attached to a slit in the doll. The slit may be opened to find a cavity, which cavity is filled with pet treats.

Under one embodiment, the doll is shaped like an animal with a Mexican theme, comprising a head, a sombrero, four legs, a tail, eyes, floppy ears, a smile with a protruding tongue, and a nose.

An enclosure means may be attached to a slit in the doll is found on the upper back of the animal, or the top of the animal. Under one embodiment, The enclosure means is attached to the slit in the doll by stitching, or sewing. The slit may be opened to reveal a cavity without soft stuffing, and with space for an object. The cavity may be filled with flavored pet treats.

In one embodiment of the method of the present invention, the user pulls on both sides of the opening with the enclosure means attached, and upon finding a hollow cavity, inserts additional pet treats into the opening. The user then closes the opening, by fastening the enclosure means.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not, therefore, to be considered to be limiting of its scope, the invention will be described and explained with additional specificity and detail through the use of the accompanying drawings, in which:

FIG. 1 is a side view illustrating one embodiment of a treat-filled doll for pets;

FIG. 2 is a side view illustrating one embodiment of a treat-filled doll for pets, with the slit opened to show the treats inside;

FIG. 3 is a side view illustrating one embodiment of a treat-filled doll for pets, showing the treats inside the doll;

FIG. 4 is a top view illustrating one embodiment of a treat-filled doll for pets;

FIG. 5 is a top view illustrating one embodiment of a treat-filled doll for pets with the slit for treats opened;

FIG. 6 is a schematic block diagram illustrating one embodiment of a method of refilling the cavity of the doll.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

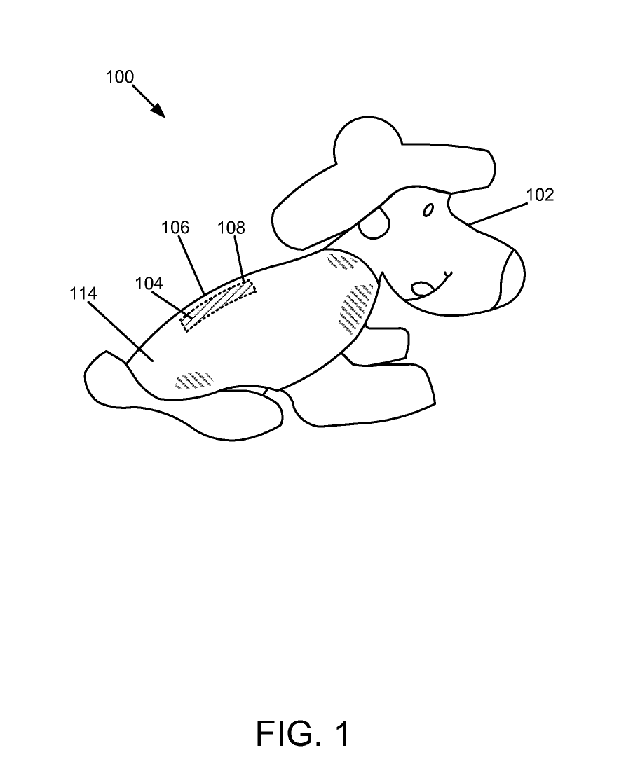

FIG. 1 depicts a system 100 in accordance with the present invention. The depicted system 100 includes a doll 102 with a hollow cavity 114 and an enclosure means 104 attached to a slit 106 by an attachment material 108.

The doll 102 may consist of any shape, including but not limited to a dog, another animal, a ball, a fire hydrant, or a bone. The preferred embodiment comprises a doll 102 in the shape of a dog that is wearing a sombrero, has two eyes, two ears, a smile with a protruding tongue, a prominent nose, a tail, and four legs.

The doll 102 may be made of plush, foam, cotton fabric, wool fabric, linens, fleece, felt, denim, canvas, latex, nylon, neoprene, vinyl, leathers, or terry cloth. The doll 102 may be a variety of sizes from three inches (3″) long and three inches (3″) high and three inches (3″) wide to twelve inches (12″) long and twelve inches (12″) high and twelve inches (12″) wide.

The doll 102 may contain additional supports, including but not limited to, extra material in the legs, arms, neck, or other area of the doll, in order to force it to sit in an upright position, or to stand in an upright position. In this embodiment, the doll 102 is void of additional support, and is limp.

The doll 102 may have additional attractions to an animal, including but not limited to a long tail, a skirt, a large hat, a protruding tongue, long ears, or other feature. The doll 102 may be made from plastic, rubber, rawhide, cardboard, or rope. The hollow cavity 114 may include of the inner walls of the doll 102, without a sack or any additional container.

In one embodiment given by way of example, the slit 106 has dimensions of between three quarters of an inch (¾″) and five inches (5″) in length. The slit 106 maybe between three quarters of an inch (¾″) and six inches (6″) in width, when the slit 106 is opened to its capacity. The slit 106 may be found in various locations, including on the back of the doll 102, underneath the doll 102, on the side of the doll 102, or on the front of the doll 102.

The slit 106 may be a hole in the doll 102 and may not be closed by an enclosure means 104, but may remain open.

In one embodiment, the enclosure means 104 comprises a hook and loop material fastening strip. The hook and loop material strip may be between three quarters of an inch (¾″) and five inches (5″) in length. The Hook and loop material strip 104 may be attached on the inner walls of the doll, inside the hollow cavity 114. The hook and loop material strip may be attached on both sides of the slit 106.

The enclosure means 104 may comprise a button, magnets, stitches, or folded fabric.

The attachment material 108 used to attach the enclosure means 104 to the slit 106, may include, but not be limited to, stitching, glue, adhesive strips, or tape.

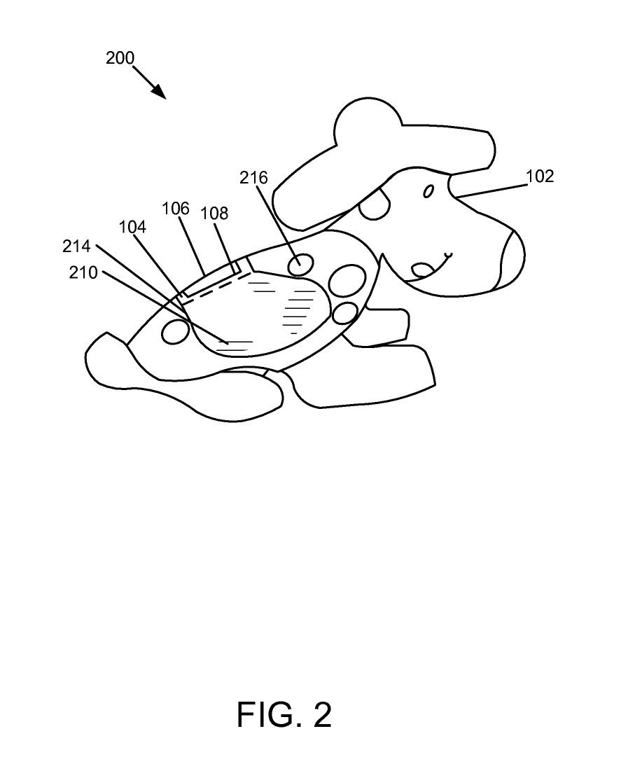

FIG. 2 depicts a system 100 in accordance with the present invention. The system 200 includes a doll 102 with an enclosure means 104 attached to a slit 106 in the doll 102 by an attachment material 108. The slit 106 in the doll 102 reveals a hollow cavity 210.

The cavity 210 in the doll 102 may include a sack-like container 214 into which an object may be placed. The cavity 210 may be stuffed, apart from the pouch. The cavity 210 may be empty, with the treat or edible substance packaged separately.

The stuffing 216 may include cotton, cotton fabric, wool fabric, linens, fleece, felt, denim, canvas, latex, nylon, neoprene, vinyl, leathers, or terry cloth.

The sack-like container 214 may comprise a cloth or hard material. The sack-like container 214 may comprise cloth, including but not limited to cotton fabric, wool fabric, linens, fleece, felt, denim, canvas, latex, nylon, neoprene, vinyl, leathers, or terry cloth.

The sack-like container 214 may comprise a hard material, including but not limited to plastic or rubber. In one embodiment, the sack-like container 214 includes one opening, which is attached by the attachment material 108 to either side and around the slit 106, so as to form a pouch in the cavity 210 of the doll 102 when the enclosure means 104 is separated and the slit 106 opened.

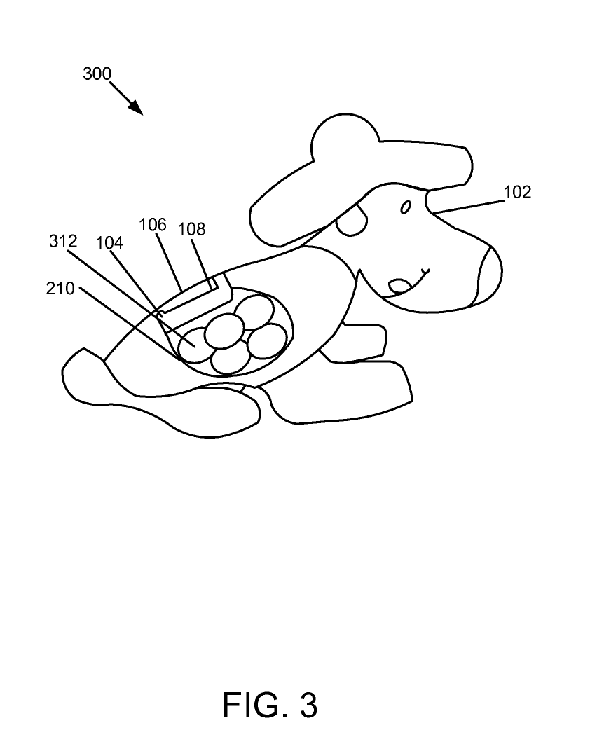

FIG. 3 depicts a system 100 in accordance with the present invention. The system 300 includes a doll 102 with an enclosure means 104 attached to a slit 106 by an attachment material 108 such as stitching. The opening is shown closed. The cavity 210 of the doll 102 is depicted as filled with treats 312.

The treats 312 may include wet or dry items. The system 300 may contain treats 312 from a quarter of one ounce (0.25 oz.) to eight ounces (8 oz.).

The treats 312 may be dog treats, vitamins, D.A.P., mood altering pheromones, supplements, medicines, or other orally ingestible substances. In the preferred embodiment, the treats are dog treats with jerky-flavoring and bacon flavoring.

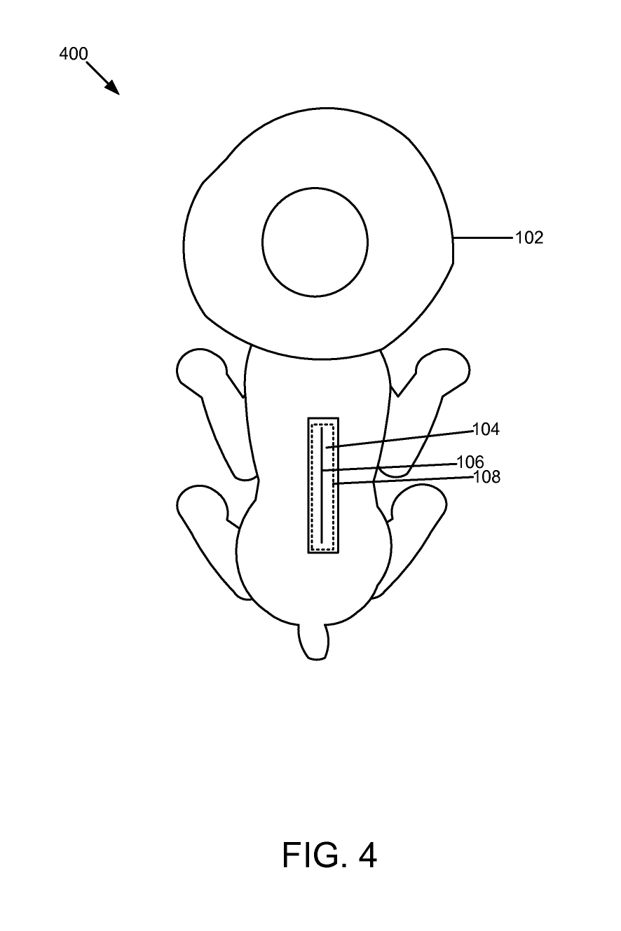

FIG. 4 depicts a system 100 in accordance with the present invention, as seen from a top view. The system 400 includes a doll 102 with an enclosure means 104 attached to a slit 106 by an attachment material 108 such as stitching. The slit 106 is shown as it would be if it were closed.

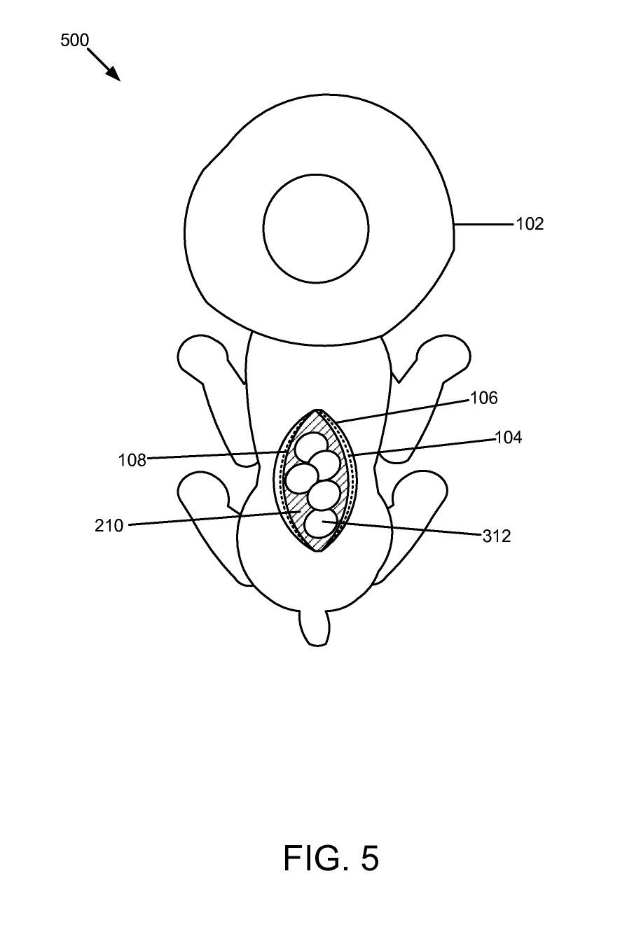

FIG. 5 depicts a system 100 in accordance with the present invention, as seen from a top view. The system 500 includes a doll 102 with an enclosure means 104 attached to a slit 106 by an attachment material 108 such as stitching. The slit 106 is shown as it would be if it were open. Inside the opening 106, there is a hollow cavity 210, which is filled with treats 312.

The schematic flow chart diagrams that follow are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

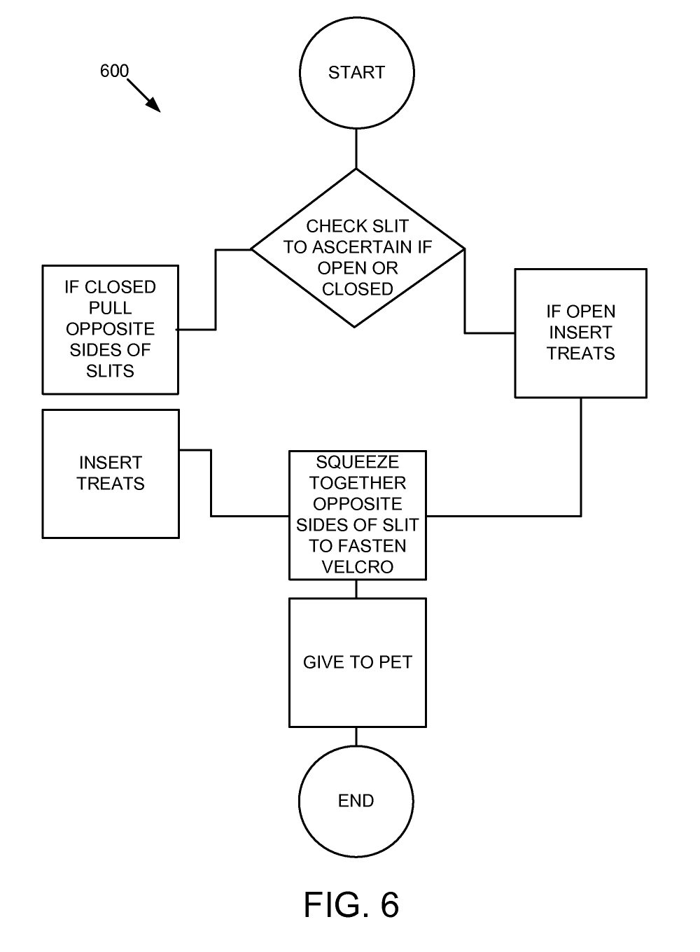

FIG. 6 is a schematic flow chart diagram illustrating one embodiment of a method for refilling the doll with treats. The user checks the slit 106 to ascertain whether the slit 106 is open or closed. If the slit 106 is open, the user inserts more treats 312. If the slit 106 is closed, the user pulls opposite sides of the slit 106 to release the enclosure means 104. The user then inserts the treats 312. After the treats 312 are inserted, the user squeezes together the opposite sides of the slit 106 to fasten the enclosure means 104. The user then gives the doll 102 back to the pet for continued use.

The present invention may be embodied in other specific forms without departing from its spirit or essential characteristics. The described embodiments are to be considered in all respects only as illustrative and not restrictive.

What is claimed is:

1. An apparatus comprising:
a doll;
a slit in the doll, the slit defining the opening of a hollow cavity
an enclosure attached to the slit; and
an edible substance for placement within the doll.

2. The apparatus of claim 1, wherein the doll is substantially entirely formed of a soft material.

3. The apparatus of claim 2, wherein the doll comprises plush, foam, cotton fabric, wool fabric, linens, fleece, felt, denim, canvas, latex, nylon, neoprene, vinyl, leathers, or terry cloth.

4. The apparatus of claim 1, wherein the doll comprises a hard material.

5. The apparatus of claim 4, wherein the doll comprises plastic, rubber, rawhide, cardboard, or rope.

6. The apparatus of claim 1, wherein the enclosure means includes a hook and loop material strip.

7. The apparatus of claim 1, wherein the enclosure means includes buttons, stitches, a magnet or magnets, and folded fabric.

8. The apparatus of claim 1, wherein the slit is between three quarters of an inch (¾″) and five inches (5″) in length, and between three quarters of an inch (¾″) and six inches (6″) in width, when the slit is opened to its capacity.

9. The apparatus of claim 1, wherein the slit comprises a hole in the doll and remains open.

10. The apparatus of claim 6, wherein the Hook and loop material strip comprises a strip between three quarters of an inch (¾″) and five inches (5″) in length.

11. The apparatus of claim 1, wherein the hollow cavity comprises the inner walls of the doll.

12. The apparatus of claim 1, wherein the hollow cavity comprises a sack-like container.

13. The apparatus of claim 12, wherein the sack-like container comprises a pouch attached to the slit by an attachment material.

14. The apparatus of claim 13, wherein the sack-like container comprises a soft material, including but not limited to plush, foam, cotton fabric, wool fabric, linens, fleece, felt, denim, canvas, latex, nylon, neoprene, vinyl, leathers, or terry cloth.

15. The apparatus of claim 13, wherein the sack-like container comprises a plastic or rubber.

16. The apparatus of claim 1, wherein the edible substance consists of one of a dog treat, a vitamins, pheromone infused vehicle of transport, including D.A.P. and other mood-altering pheromones, a suppplement, and a medicine.

17. The apparatus of claim 1, wherein the edible substance is disposed within the hollow cavity.

18. The apparatus of claim 1, wherein the edible substance is included with the doll package, but in a separate airtight bag.

19. An apparatus comprising:
a doll;
a slit in the doll, the slit defining the opening of a hollow cavity
an enclosure attached to the slit;
an edible substance placed within the enclosure; and
a hook and loop material strip providing a sealing mechanism for the enclosure.

20. An apparatus comprising:
a doll;
a slit in the doll, the slit defining the opening of a hollow cavity
an enclosure attached to the slit;
an edible substance; and
a hook and loop material strip providing a sealing mechanism for the enclosure, and the edible substance sealably disposed within the hollow cavity.
